(19) United States
(12) Patent Application Publication
(10) Pub. No.: US 2025/0247207 A1
(43) Pub. Date: Jul. 31, 2025

(54) METHOD AND APPARATUS WITH HOMOMORPHIC ENCRYPTION OPERATION

(71) Applicants: Samsung Electronics Co., Ltd., Suwon-si (KR); Seoul National University R&DB Foundation, Seoul (KR)

(72) Inventors: Yongsoo SONG, Seoul (KR); Seonhong MIN, Seoul (KR); Dongwon LEE, Seoul (KR)

(73) Assignees: Samsung Electronics Co., Ltd., Suwon-si (KR); Seoul National University R&DB Foundation, Seoul (KR)

(21) Appl. No.: 18/824,105

(22) Filed: Sep. 4, 2024

(30) Foreign Application Priority Data
Jan. 26, 2024 (KR) 10-2024-0012551
Jun. 3, 2024 (KR) 10-2024-0072644

(51) Int. Cl. H04L 9/06; H04L 9/00; H04L 9/30

(52) U.S. Cl. CPC H04L 9/0618; H04L 9/008; H04L 9/3026

(57) ABSTRACT

A method and apparatus for a homomorphic encryption operation are disclosed. A bootstrapping method for a homomorphically encrypted ciphertext includes generating a first ciphertext of a plaintext corresponding to a ciphertext modulus of a third value, based on an input ciphertext of the plaintext corresponding to a ciphertext modulus of a first value and corresponding to a ciphertext modulus of a second value, generating a second ciphertext corresponding to the ciphertext modulus of the second value and corresponding to the ciphertext modulus of the third value, based on the first ciphertext, the second value, and the third value, and generating a third ciphertext of an evaluation result of a target function for the plaintext corresponding to a plaintext modulus of a fourth value, based on the second ciphertext and the target function.

### CROSS-REFERENCE TO RELATED APPLICATIONS

This application claims the benefit under 35 USC § 119 (a) of Korean Patent Application No. 10-2024-0012551, filed on Jan. 26, 2024, and Korean Patent Application No. 10-2024-0072644, filed on Jun. 3, 2024, in the Korean Intellectual Property Office, the entire disclosures of which are incorporated herein by reference for all purposes.

### BACKGROUND

### 1. Field

The following description relates to a method and apparatus with a homomorphic encryption operation.

### 2. Description of Related Art

In fully homomorphic encryption (FHE) schemes, a function may be performed on encrypted data without having to decrypt the encrypted data. This prevents the exposure of personal information while manipulating data in an untrusted environment. FHE studies have been conducted based on the learning with errors (LWE) problem or the ring LWE (RLWE) problem, which is a ring or ring transformation of the LWE problem. A ciphertext in an FHE scheme includes noise, and the noise increases while a homomorphic operation is performed on the ciphertext. Since noise greater than or equal to a certain size makes a decryption result incorrect, noise management may be implemented while performing a function on a FHE ciphertext. Although there is noise reduction technology, such as a Residue Number System (RNS)-based gadget decomposition technique or a modulus technique, limiting noise increase during a homomorphic operation is difficult. A process to reduce the noise of a ciphertext after many operations is necessary. A bootstrapping method has been proposed for this process.

Bootstrapping is technology used for homomorphically evaluating a decryption circuit to refresh a ciphertext. Since an operation for a decryption circuit is not easily supported in FHE schemes, bootstrapping is a costly operation. To efficiently perform bootstrapping, optimization may be applied to improve performance, or a decryption circuit may be redesigned for simplification. For example, many studies on Cheon-Kim-Kim-Song (CKKS) bootstrapping optimize the modulus operation approximation of a decryption circuit.

Studies on Fan-Vercauteren (FV) focus on a method of reducing noise in a ciphertext while retaining a message value. Accordingly, when evaluating a high-order circuit, bootstrapping does not affect an operation of the circuit.

Furthermore, existing approaches may perform bootstrapping while maintaining a modulus without using a plaintext modulus. Thus, all pieces of data used for evaluation need to be encrypted with the same plaintext modulus. However, depending on the properties of data (e.g., a data range or pieces of the data), each piece of data may have appropriate parameters. A set of parameters appropriate for data may lead to performance enhancement or flexible packing in a ciphertext. In addition, since not all the pieces of data need to be encrypted with the same parameter set, bootstrapping technology that is flexible to a modulus change may be beneficial.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects may provide bootstrapping technology of homomorphic encryption that overcomes the limitation that a plaintext modulus should not be changed to another modulus.

Aspects may provide bootstrapping technology of homomorphic encryption that overcomes the limitation that an evaluation of a function may not performed during bootstrapping.

However, technical aspects are not limited to the foregoing aspects, and there may be other technical aspects.

In one general aspect, a bootstrapping method for a homomorphically encrypted ciphertext includes generating a first ciphertext of a plaintext corresponding to a ciphertext modulus of a third value, based on an input ciphertext of the plaintext corresponding to a ciphertext modulus of a first value and corresponding to a ciphertext modulus of a second value; generating a second ciphertext corresponding to the ciphertext modulus of the second value and corresponding to the ciphertext modulus of the third value, based on the first ciphertext, the second value, and the third value; and generating a third ciphertext of an evaluation result of a target function for the plaintext corresponding to a plaintext modulus of a fourth value, based on the second ciphertext and the target function. The third value is the same as the fourth value or a power of the fourth value.

The generating of the first ciphertext may include transforming the first ciphertext of a message vector form into a polynomial form, based on a slot-to-coefficient operation.

The generating of the second ciphertext may include transforming the second ciphertext of a polynomial form into a message vector form, based on a slot-to-coefficient operation.

The generating of the second ciphertext may include generating the second ciphertext by multiplying the first ciphertext by a reciprocal of the third value and the second value.

The generating of the third ciphertext may include moving coefficients of the plaintext included in the second ciphertext of a polynomial form to a message slot, based on a slot-to-coefficient operation; and generating the third ciphertext based on a polynomial configured to map a value of the message slot of the second ciphertext to the evaluation result of the target function for the plaintext when the third value is the same as the fourth value.

The generating of the third ciphertext may include moving coefficients of the plaintext included in the second ciphertext of a polynomial form to a message slot, based on a slot-to-coefficient operation; and switching the plaintext modulus into an r−1 power of the fourth value by performing a division operation on the fourth value based on a polynomial where a value of the message slot is a multiple of the fourth value when the third value is an r power of the fourth value for a natural number r that is greater than or equal to 2.

The bootstrapping method may further include repeating the transforming of the plaintext modulus into the r−1 power of the fourth value until the plaintext modulus is switched to the fourth value, and generating the third ciphertext based on a polynomial configured to map a value of the message slot of the second ciphertext to the evaluation result of the target function for the plaintext when the plaintext modulus is the fourth value.

The target function may include a look-up table (LUT) operation.

The target function may include a step function.

The input ciphertext may be generated by a Fan-Vercauteren (FV) scheme or a Cheon-Kim-Kim-Song (CKKS) scheme.

In another general aspect, an apparatus for performing a bootstrapping method for a homomorphically encrypted ciphertext includes one or more processors configured to generate a first ciphertext of a plaintext corresponding to a ciphertext modulus of a third value, based on an input ciphertext of the plaintext corresponding to a ciphertext modulus of a first value and corresponding to a ciphertext modulus of a second value, generate a second ciphertext corresponding to the ciphertext modulus of the second value and corresponding to the ciphertext modulus of the third value, based on the first ciphertext, the second value, and the third value, and generate a third ciphertext of an evaluation result of a target function for the plaintext corresponding to a plaintext modulus of a fourth value, based on the second ciphertext and the target function. The third value is the same as the fourth value or a power of the fourth value.

The one or more processors, when generating the first ciphertext, may transform the first ciphertext of a message vector form into a polynomial form, based on a slot-to-coefficient operation.

The one or more processors, when generating the second ciphertext, may transform the second ciphertext of a polynomial form into a message vector form, based on a slot-to-coefficient operation.

The one or more processors, when generating the second ciphertext, may generate the second ciphertext by multiplying the first ciphertext by a reciprocal of the third value and the second value.

The one or more processors, when generating the third ciphertext, may move coefficients of the plaintext included in the second ciphertext of a polynomial form to a message slot, based on a slot-to-coefficient operation, and may generate the third ciphertext based on a polynomial configured to map a value of the message slot of the second ciphertext to the evaluation result of the target function for the plaintext when the third value is the same as the fourth value.

The one or more processors, when generating the third ciphertext, may move coefficients of the plaintext included in the second ciphertext of a polynomial form to a message slot, based on a slot-to-coefficient operation, and may switch the plaintext modulus into an r−1 power of the fourth value by performing a division operation on the fourth value based on a polynomial where a value of the message slot is a multiple of the fourth value when the third value is an r power of the fourth value for a natural number r that is greater than or equal to 2.

The one or more processors may repeat the switching of the plaintext modulus into the r−1 power of the fourth value until the plaintext modulus is switched to the fourth value and may generate the third ciphertext based on a polynomial configured to map a value of the message slot of the second ciphertext to the evaluation result of the target function for the plaintext when the plaintext modulus is the fourth value.

The target function may include a LUT operation or a step function.

The target function may be performed on the ciphertext while noise of the ciphertext is reduced.

Other features and aspects will be apparent from the following detailed description, the drawings, and the claims.

### BRIEF DESCRIPTION OF THE DRAWINGS

FIG. 1 illustrates an example of a homomorphic encryption system according to one or more embodiments.

FIG. 2 illustrates an example of functional bootstrapping according to one or more embodiments.

FIG. 3 illustrates an example of a pipeline of Fan-Vercauteren (FV) bootstrapping of a slim mode, according to one or more embodiments.

FIG. 4 illustrates an example of an entire pipeline of the functional bootstrapping according to one or more embodiments.

FIG. 5 illustrates an example of the functional bootstrapping according to one or more embodiments.

FIG. 6 illustrates an example of an algorithm for evaluating a step function according to one or more embodiments.

FIG. 7 illustrates an example of a bootstrapping method for a homomorphically encrypted ciphertext, according to one or more embodiments.

FIG. 8 illustrates an example of a changing process of a modulus and a ciphertext in a functional bootstrapping process, according to one or more embodiments.

FIG. 9 illustrates an example configuration of an apparatus according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

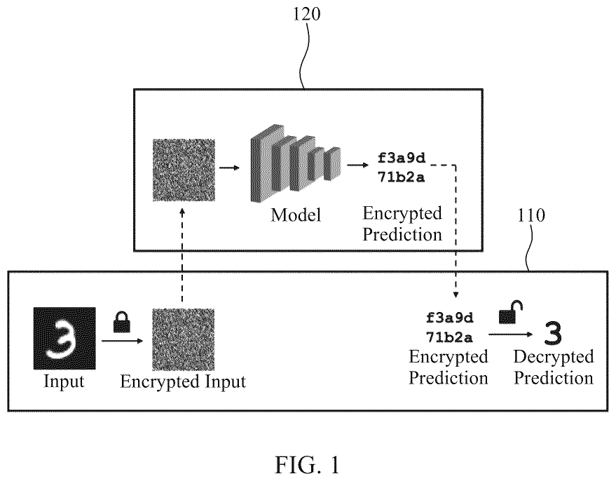

FIG. 1 illustrates an example of a homomorphic encryption system according to one or more embodiments.

Referring to FIG. 1, the homomorphic encryption system may include a client 110 and a server 120 as main components. The client 110 and server 120 may be implemented on respective computing devices and may communicate via a network, for example. The client 110 may receive ciphertext from the server 120, as manipulated by the server 120, and decrypt the manipulated ciphertext to recover the original cleartext message, albeit transformed as per the operation of the server 120.

The homomorphic encryption system may allow the server 120 to provide an artificial intelligence service, for example, to the client 110 without directly exposing data retained by the client 110 to the server 120. That is to say, the server 120 may perform an operation that transforms a homomorphically encrypted ciphertext received from the client 110.

The client 110 may be an agent that uses the artificial intelligence service of the server 120 and may be referred to as a service-using entity, a service user, a data owner, or the like. The client 110 may encrypt its own data (e.g., an image) through a client terminal based on a homomorphic encryption technique and may transmit the encrypted data to the server 120. The client terminal may also be referred to as a user terminal.

Homomorphic encryption is an encryption technique for transforming encrypted data without having to decrypt the encrypted data. When various operations are performed on homomorphically encrypted data, and the encrypted data is later decrypted, the decrypted data will be the same as if the operations had been performed on the original unencrypted data. For example, a function operation (without decryption) may be performed on the encrypted data in fully homomorphic encryption (FHE), and the encrypted data may still be decrypted even in its form as transformed by the function operation. Homomorphic encryption may process data in its encrypted state, and thus may address privacy concerns in the data industry.

The server 120 may receive the encrypted data from the client 110 and may transmit an artificial intelligence operation result performed on the encrypted data to the client 110. The server 120 may be referred to as a service provider, a service-providing entity, or the like.

The server 120 may provide various artificial intelligence services to the client 110. For example, the server 120 may provide the client 110 with a service, such as face recognition or mask detection, where maintaining the confidentiality of user data is desirable. However, an operation required for providing an artificial intelligence service generally requires a large amount of memory and extensive network data transmission. For example, while encrypting data for convolutional neural network inference (e.g., the example shown in FIG. 1), numerous homomorphic ciphertexts are generated, demanding a large amount of memory and extensive network data transmission.

Ciphertexts in FHE schemes include noise, and the noise increases while a homomorphic operation is performed. Noise greater than or equal to a certain size makes a decryption result incorrect. Thus, during a decryption procedure of a ciphertext, a noise reduction in the ciphertext through bootstrapping may be used. In other words, bootstrapping may be a homomorphic evaluation performed by a decryption circuit to reduce noise.

A bootstrapping method according to one or more embodiments described herein may be referred to as functional bootstrapping.

Functional bootstrapping according to one or more embodiments may include bootstrapping based on a Fan-Vercauteren (FV) scheme. When an initial plaintext modulus is p^{e}, which is a power of a prime number p, the functional bootstrapping may transform a plaintext modulus p^{e} into q^{e}, a power of a prime number q, after bootstrapping.

The functional bootstrapping according to an embodiment may perform a function evaluation as well as the calculation of the decryption procedure. For example, the functional bootstrapping may be used for an algorithm to evaluate a look-up table (LUT) under the condition where a polynomial likely exists in Zₚr. In theory, regardless of the temporal complexity or depth of a circuit, an operation of the circuit may be performed with one functional bootstrapping procedure.

By using the functional bootstrapping according to one or more embodiments, an LUT evaluation algorithm may be optimized for a function, such as a sign function or a delta function, which is not easily supported in an FHE operation. To operate this function, an LUT operation corresponding to a step function is used. The functional bootstrapping is described below.

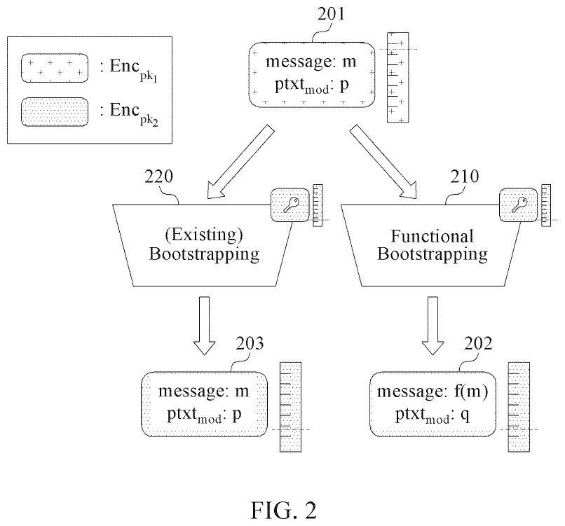

FIG. 2 illustrates an example of a concept of functional bootstrapping according to one or more embodiments.

Referring to FIG. 2, a functional bootstrapping module 210 may receive a ciphertext 201 of a message m having a plaintext modulus p as an input and may generate a ciphertext 202 of f(m) having a plaintext modulus q for a function f. For example, the ciphertext 201 of the message m having the plaintext modulus p may be generated by encrypting the message m having the plaintext modulus p with a first public key pk₁. For example, the ciphertext 202 of f(m) having the plaintext modulus q may be generated by encrypting f(m) having the plaintext modulus q with a second public key pk₂.

According to an embodiment, when a function f:Zₚ→Z_{q} to be operated is given, the functional bootstrapping 210 may generate the ciphertext 202 of f(m) from the ciphertext 201 of the message m having the plaintext modulus p.

In other words, the ciphertext 202 output as a result of functional bootstrapping for the ciphertext 201 (of the message m having the plaintext modulus p) may correspond to a ciphertext of f(m) having the plaintext modulus q.

The functional bootstrapping module 210 is configured for reducing noise in a ciphertext, which enables a function evaluation/performance.

A typical bootstrapping module 220 only uses a method of reducing noise in a ciphertext without changing the corresponding message and may obtain, as a bootstrapping result, a ciphertext 203 having small noise while maintaining a value of the message. In other words, a plaintext modulus of an output ciphertext 203 of the typical bootstrapping module 220 is not changed from (is the same as) the plaintext modulus of the input ciphertext 201 of the typical bootstrapping module 220. Thus, bootstrapping when evaluating/performing a high-order circuit is only used as a building block for the specific purpose of reducing noise and does not affect the performance of a circuit evaluation/performance, for example, the depth of the circuit.

The functional bootstrapping module 210 is a new bootstrapping method of performing some operations on a message while reducing noise in a ciphertext. That is, some operations may be performed on a ciphertext while at the same time noise of the ciphertext is reduced.

During operation of the functional bootstrapping module 210, a plaintext modulus may be switched from a prime number p to another prime number q. In the typical bootstrapping module 220, through digit extraction, a plaintext modulus may be switched from p^{r} to p^{e} (r>e) for the prime number p, but the plaintext modulus switching is only allowed for the same p base. In addition, the ciphertext 203 output as a result of the typical bootstrapping module 220 may have the same message space as that of the input ciphertext 201 (e.g., the message is unchanged).

The functional bootstrapping module 210 may generalize the transformation of a plaintext modulus and may allow the modulus to be switched to the prime number q on a different base to improve the flexibility of an FV scheme. This enables an arithmetic operation between ciphertexts having respective different plaintext moduli. In other words, in the case of the functional bootstrapping module 210, unlike the typical bootstrapping module 220, is not limited to a fixed plaintext modulus. Put yet another way, the plaintext modulus of the input ciphertext 201 does not need to be the same as the plaintext modulus of the output ciphertext 202.

In addition, the functional bootstrapping module 210, unlike the typical bootstrapping module 220 that only performs an operation to reduce noise, may perform a bootstrapping operation to reduce noise and a function operation on a message.

According to an embodiment, the functional bootstrapping module 210 may change a message space of a ciphertext, and thus may perform an operation between ciphertexts on different message spaces. In other words, an operation between two ciphertexts may be performed by transforming a message space of one ciphertext into a message space of the other ciphertext and unifying the message space of the two ciphertexts.

Hereinafter, N is assumed to be a power of 2. In the case of m=2N, an integer residue ring of an m-th cyclotomic field is denoted by R=Z[X]/Φₘ(X), and a residue ring as a module of R for an integer p is denoted by Rₚ=Zₚ[X]/Φₘ(X). In addition, a plaintext space is denoted by Rₚ=Zₚ[X]/F₁× . . . ×Zₚ[X]/Fₖ. Here, each FᵢϵZₚ[X] is a ring polynomial of a degree d of Z′ₘ for p. Φₘ(X)=Πᵢ₌₁^{k}Fᵢ(X)(mod p). p and q respectively indicate plaintext moduli of input and output messages.

Z∩(−Q/2, Q/2] is used as a representative of Z_{Q}, and [a]Q is a module of “a” for Q and indicates a decrease. x←D indicates that x is extracted from a distribution D. U(S) represents a uniform distribution over a finite set S. For σ>0, D_{σ} represents a distribution over R, which independently samples N coefficients in a discrete Gaussian distribution of a distribution σ², and x represents a key distribution.

Also, a̅ᵣ̅₋̅₁̅a̅ᵣ̅₋̅₂̅ .̅ .̅ .̅ a̅₀̅ represents a base representation of aϵZₚr. Here, aᵢϵZₚ, that is, a=Σᵢ₌₀^{r}aᵢp^{l}.

Since the functional bootstrapping module 210, according to one or more embodiments, is based on an FV scheme, the FV scheme is described first.

An FV ciphertext may include two polynomials of a ring R_{Q}=Z_{Q}[X]/Φₘ(X). Descriptions of known general technologies, such as gadget decomposition technology for managing noise or a homomorphic operation including addition or multiplication, may be found elsewhere.

FV.Setup(1^{λ}): A cyclotomic degree m, a plaintext modulus p, a ciphertext modulus Q, a key distribution x over R, and an error parameter σ are set. An output parameter set is pp=(m, p, Q, x, σ). The plaintext modulus p is a prime number that is not divisible by m. Also, Δ=└Q/p┐.

FV.KeyGen: s←x, a←U(R_{Q}), and e←D_{σ} are sampled. A secret key sk and a public key pk are respectively set as sk=s and pk=(b, a)ϵR²_{Q}. Here, b=−s·a+e(mod Q).

FV.Encode(m): When mϵZ^{k}ₚ is given, μ=σ⁻¹(m) is returned. Here, σ:μ⇒(u mod Fi)_{1≤i≤k}.

FV.Decode(pk; μ): When wϵx is given, m=σ(μ) is returned.

FV.Enc(pk; μ): w←x and e₀, e₁←D_{σ} are sampled. When encoding μϵRₚ is given, a ciphertext ct=w·pk+(Δ·μ+e₀, e₁) (mod Q) is output.

FV.Dec(sk; ct): When the secret key {sk} related to the ciphertext ct=(c₀, c₁)ϵR²_{Q} is given, μ=└(p/_{Q})·(c₀+c₁·s)┐ (mod p) is returned.

FV bootstrapping may be performed similarly to a Brakerski-Gentry-Vaikuntanathan (BGV) scheme. The FV bootstrapping may be performed in four steps: (1) a modulus switching and dot product operation, (2) a linear transform operation, (3) a polynomial evaluation and digit extraction operation, and (4) an inverse linear transform operation. In the modulus switching and dot product operation (1), a ciphertext may be homomorphically decrypted, and in the linear transform operation (2) or the inverse linear transform operation (4), encoding and decoding may be performed.

A major bottleneck of FV/BGV bootstrapping may be a digit extraction procedure (bootstrapping step (3) mentioned immediately above), which has the function of removing a certain least significant digit from the p base. wϵZₚr is a digit extraction algorithm and, when wᵢϵZₚ, may be expressed by Equation 1 below.

$$w = {\sum }_{i = 1}^{r} {w}_{i} {p}^{i} \qquad Equation 1$$

To achieve a digit extraction function, the least-significant digit is wᵢ, and w_{i,j}, in which all the subsequent j least-significant digits are 0, may be calculated. v least-significant digits, in which v is less than r, may be removed by removing w_{0,r-1}, w_{1,r-2}, . . . , w_{v-1,r-v} from an input. A lifting polynomial is a main component, which outputs w_{i,j+1} for the input w_{i,j}. By repeating polynomial lifting j times, w_{i,j} may be obtained.

The FV bootstrapping may be optimized by modifying the digit extraction operation. For example, bootstrapping performance may be improved by finding a digit extraction polynomial (or a least significant digit removal polynomial), which is an efficient polynomial with a low degree. For example, by using the digit extraction polynomial, w_{i,r-i-1} may be evaluated with no need to calculate w_{i,k} for all 0≤k≤r−i−1, and thus, overall digit extraction performance may be improved.

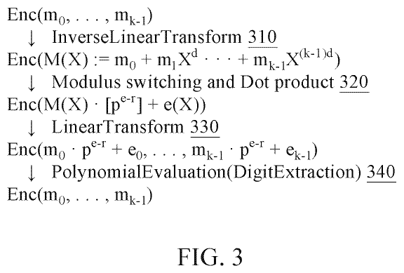

FIG. 3 illustrates an example of a pipeline of FV bootstrapping of a slim mode, according to one or more embodiments.

Referring to FIG. 3, bootstrapping in the slim mode puts a message into a single polynomial by evaluating an inverse linear transform matrix through inverse linear transform operation 310 before performing modulus switching and dot product operation 320. Accordingly, the bootstrapping may be performed d times faster, where d is a multiplication degree of p in Z′ₘ.

Each operation of the bootstrapping in the slim mode is described below.

Linear transform operation 310: When mᵢϵZₚ (0≤i<k) in FV encryption of a vector \vec{m}=(mᵢ)_{0≤i<k}, a ciphertext of a plaintext M(X) may be obtained by performing a homomorphic discrete Fourier transform (DFT) first. The plaintext M(X) may be defined as M(X):=m₀+m₁X^{d}+ . . . +mₖ₋₁X^{(k-1)d}.

Modulus switching and dot product operation 320: By using a scale-invariant feature of an FV ciphertext, FV encryption (c′₀, c′₁)ϵRₚ_{ᵣ}² may be obtained by changing a ciphertext modulus to p^{r}. In FV, a modulus may be simply switched through scaling and rounding for each ciphertext component, that is, of c′ᵢ=└q^{r}/p·cᵢ┐. Then, when an encrypted secret key s is given as a new plaintext modulus p^{r}, c′₀+c′₁·s may be homomorphically calculated. A resultant ciphertext in this operation may be a ciphertext of M(X)·p^{r-1}+e(X)ϵRₚ_{ᵣ}, for an error polynomial e that satisfies ∥e∥∞<p^{r-1}/2. e(X) denotes noise or an error (or a defect) and is a polynomial with a small size.

Inverse transformation operation 330: The FV ciphertext for the vector (mᵢ·p^{r-1}+eᵢ)_{0≤t<k} of the plaintext modulus p^{r} may be obtained by performing a homomorphic inverse DFT (iDFT). Here, eᵢ is an i·d-degree coefficient of the error polynomial e for 0≤i<k.

Polynomial evaluation (or digit extraction) operation 340: The uppermost digit of a p-base representation of a message may be homomorphically extracted. To this end, a lifting polynomial {Fᵢ} and a digit extraction polynomial {Gᵢ} may be used. An i-th lifting polynomial Fᵢ is a polynomial defined in Zₚ_{ᵢ} and satisfies Fᵢ(x·p^{j}+y)=y (mod p^{j+1}) for 0<j<i, 0≤x<p^{i-j}, and 0≤y<p. An i-th digit extraction polynomial Gᵢ is a polynomial defined in Zₚ_{ᵢ} and satisfies Gᵢ(x·p+y)=y(mod pⁱ) for 0≤x<pⁱ⁻¹ and 0<y<p. Gᵢ is essentially the same as i times of iterative compositions of Fᵢ. By evaluating such a polynomial and homomorphically dividing a plaintext by p, lower bits may be repeatedly removed; details are described below.

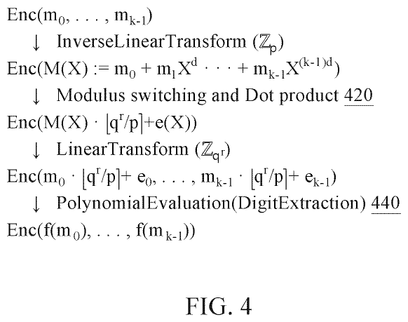

FIG. 4 illustrates an example of an entire pipeline of the functional bootstrapping according to one or more embodiments.

The functional bootstrapping according to one or more embodiments described herein has several differences from the typical prior bootstrapping (described with reference to FIG. 3) in modulus switching and dot product operation 420 and polynomial evaluation operation 440. Through the modulus switching and dot product operation 420 of the functional bootstrapping, a ciphertext modulus may be switched to q^{r} and a ciphertext of M(X)·└q^{r}/p┐+e(X) may be obtained. Through the polynomial evaluation operation 440 of the functional bootstrapping, a ciphertext of f(mᵢ) for a polynomial f may be obtained. These differences may give the functional bootstrapping two major advantages over a typical bootstrapping method.

The first advantage is that a plaintext modulus of a ciphertext may be changed during the functional bootstrapping. The modulus switching and dot product operation 420 of the functional bootstrapping may involve switching a plaintext modulus corresponding to multiple values of a message space into which a single input message is transformed. When there is an operation performed (proceeded with in-polynomial evaluation) such that these multiple values have the same value, an output ciphertext may be the encryption of a transformed message space having a plaintext modulus that is different from its original before the operation. For example, when there is an operation to output the same value for multiple values that correspond to an input, the functional bootstrapping may be different from the typical bootstrapping in that a plaintext modulus may be changed.

The second advantage is that an LUT may be evaluated during the functional bootstrapping. To achieve this function, an operation performed to have a value that is not the same as an input may be possible.

### Plaintext Modulus Switching Method

The method of switching a plaintext modulus in the functional bootstrapping is described next. Plaintext moduli of input and output are respectively denoted by p and q. These are assumed to be fixed prime numbers, and an input message and a secret key are respectively denoted by m and s. The basic approach is to replace a message space during the modulus switching and dot product operation of bootstrapping.

Modulus switching technology may generate additional noise in a ciphertext due to rounding error. Accordingly, for the accuracy of a message, a modulus may not be arbitrarily switched to a small value. However, in the modulus switching operation of the functional bootstrapping, the modulus may need to be changed to a small value for efficiency. The lemma below provides a lower limit for the size of a modulus in an FV scheme.

Lemma 3.1: For an initial plaintext modulus p, a ciphertext modulus q, and an FV ciphertext (c₀, c₁), that is, c₀+c₁·s=Δ·m+v+ap(|v|<Δ/4), a ciphertext (c′₀, c′₁) after switched to a modulus q′ is decrypted to m when q′>4p(1+∥s∥₁).

Proof: The decryption of an initial ciphertext for noise v is assumed to be as shown in Equation 2 below.

$$\frac{p}{q} \cdot ( {c}_{0} + {c}_{1} s ) = m + v + rp \qquad Equation 2$$

When ∥v∥<1/2, Equation 2 above is valid. For the new modulus q′, Equation 3 below is valid.

$$\frac{p}{{q}^{′}} ( \frac{{q}^{′}}{q} {c}_{0} + \frac{{q}^{′}}{q} {c}_{1} s ) = m + υ + rt \qquad Equation 3$$

Accordingly, when modulus switching to q′ is performed, for a rounding error δ, that is, ∥δ∥≤p/q′(1+∥s∥₁), Equation 4 below may be obtained.

$$\frac{p}{{q}^{′}} ( ⌊ \frac{{q}^{′}}{q} {c}_{0} ⌉ + ⌊ \frac{{q}^{′}}{q} {c}_{1} s ⌉ ) = m + υ + rt + δ \qquad Equation 4$$

New noise v′ may be denoted by v′=v+δv′=v+δ. For correct decryption, since |v|<Δ4, ∥δ∥<1/4. Accordingly, a lower limit of q′ may be determined as shown in Equation 5 below.

$${q}^{′} > 4 p ( 1 + {‖ s ‖}_{1} ) \qquad Equation 5$$

According to one or more embodiments, the lower limit of q′ may decrease to a stricter value. The secret key s is assumed to be uniformly selected together with a hamming weight h in a ternary set of {−1, 0, 1}. A rounding error follows an Irwin-Hall distribution since the rounding error may be used as a sum of h+1 uniformly distributed variables. When a failure probability is less than 2⁻¹⁵ and a ring dimension is 2¹⁵, the rounding error may be limited to p/q·1.81\sqrt{h}. Thus, inferentially, the boundary of q in lemma 3.1 may be reduced as shown in Equation 6 below.

$$q > 7.24 p \cdot \sqrt{1 + {‖ s ‖}_{1}} \qquad Equation 6$$

The following description relates to a detailed method of changing a message space (a plaintext modulus) during the modulus switching and dot product operation.

First, using a certain integer r, the method causes p and q^{r} to satisfy the conditions of lemma 3.1 or Equation 6. It may be understood that, after a ciphertext modulus is changed to q^{r}, a ciphertext may embrace a rounding error. When an input ciphertext is given, the ciphertext is modified to ct=(c₀, c₁) to be c₀+c₁·s=└q^{r}/p┐·m+e for an encryption error e. FV is a scale-invariant HE scheme, and thus, regardless of an initial ciphertext modulus, the ciphertext ct may be easily generated by applying modulus switching technology to q^{r}.

When the ciphertext ct and a greater ciphertext modulus Q(>p, q^{r}) are given, the ciphertext may be changed to ct′=(c′₀,c′₁)=(└c₀·Q/q^{r}┐, └c₁·Q/q^{r}┐) by applying a dot product. This ciphertext may be used as the encryption of a plaintext └q^{r}/p┐·m+e′ Here, the moduli of the plaintext and the ciphertext are q^{r} and Q, respectively. As a range of the plaintext is expanded, the single input may correspond to various values according to the error e. For example, an input m=0 may be a range of [−q^{r}/2p, q^{r}/2p), which is a range of an error e′ in ct′.

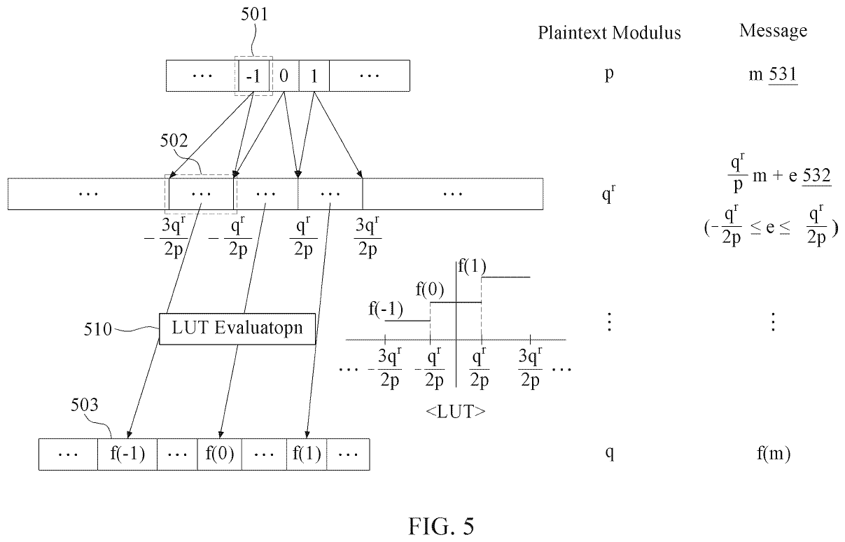

FIG. 5 illustrates an example of the functional bootstrapping according to one or more embodiments.

### LUT Evaluation Method

To achieve the functionality of the functional bootstrapping, a function that returns the same output for multiple values corresponding to a single input needs to be found. In other words, a LUT evaluation 510 may be performed with Z_{q} in Z_{q}r. For example, in a simple case that r=1, when q is a single prime number, it is well known that there is a polynomial with the maximum degree being q in which each input of Z_{q} is returned as a desired value of Z_{q}.

Referring to FIG. 5, according to a plaintext modulus switching method, an input message m 531 is related to multiple values of └q^{r}/p┐·m+e 532, which is −q^{r}/2p≤e≤q^{r}/2p. └q^{r}/p┐·m is a fixed value for each m, and thus, └q^{r}/p┐·m+e 532 may be a consecutive value in an integer domain. In addition, these values are derived from the single input m 531, and thus, an output of the functional bootstrapping should be the same as all values of └q^{r}/p┐·m+e 532, which is −q^{r}/2p≤e≤q^{r}/2p. For example, a value of └q^{r}/p┐·m+e 532, which is −q^{r}/2p≤e≤q^{r}/2p, corresponding to m=−1 501, may include values of a [−3q^{r}/2p, −q^{r}/2p) range 502. All the values of the [−3q^{r}/2p, −q^{r}/2p) range 502 may be output as f(−1) 503. Accordingly, an LUT may be the same as a step function.

Conceptually, for the LUT evaluation 510, an evaluation from Z_{q}r to Z may be a recursive evaluation of an appropriate polynomial from Z_{q}_{^{k+1}} to Z^{k}_{q} for all 1≤k≤r−1. In the case of typical bootstrapping, this polynomial is a lifting polynomial. With typical prior bootstrapping, there has been a digit extraction polynomial from Z_{q}_{^{k}} to Z^{l}_{q} for l<k, but this is a special case where there is a polynomial that may decrease a multi-degree of a p base. In general, there is no such polynomial. A method of finding a polynomial from Z_{q}_{^{k}} to Z^{l}_{q} for l<k for an LUT is described below.

A method of evaluating a step function defined in a commutative ring Zₚr for the prime number p is described in detail. To directly find a polynomial for an LUT from Zₚr to Zₚ, a polynomial from Zₚr to Zₚr needs to be found. Here, an output is the multiplication of an LUT output and p^{r-1}. In general, this polynomial exists for only several LUTs. This is because most of the functions defined in the commutative ring Zₚr do not exist in polynomials having integer coefficients, that is, polyfunctions. Accordingly, it is important to examine the polynomial structure of Zₚr.

A necessary and sufficient condition for a polyfunction in Zₚr is as below.

Proposition 4.1: If a function may be expressed by a linear combination of functions of Equation 7 below on Zₚr, it is a polyfunction.

$$( 1 ) {u}_{0}^{r} ( x ) = \{ \begin{matrix}0 & for p x \\ x & for p \vert x\end{matrix} \\ ( 2 ) {u}_{i}^{r} ( x ) , i ‐ th shift of {u}_{0}^{r} ( x ) , i . e . , {u}_{i}^{r} ( x ) = {u}_{0}^{r} ( x - i ) ( 0 \leq i < p ) \\ ( 3 ) j ‐ th powers of {u}_{i}^{r} ( x ) , i . e . , ( {{u}_{i}^{r} ( x )}^{j} = \{ \begin{matrix}0 & for p x \\ {x}^{j} & for p \vert x\end{matrix} \\ ( 0 \leq i < p , 0 \leq j < r ) \qquad Equation 7$$

Here, i used as an index related to an output of u^{r}ᵢ(x) may be used as an index for shifting. i may be replaced by an index j stated in item (3) of Equation 7, and a representation of uᵢ(x) that has been divided into two cases when i=0 and 1≤i≤r−1 may be integrated by changing the boundary of the index j.

The implication of Proposition 4.1 is that, if a function f is a polyfunction, the limiting of its domain to an i module in an equivalence class of p is to be a polynomial of a maximum degree r for 0≤i<p. A simple example is a digit extraction polynomial {Gᵢ} that is often used for FV/BGV schemes in the latest bootstrapping methods. In short, an i-th digit extraction polynomial Gᵢ is a polynomial that satisfies Gᵢ(x)=[x]ₚ (mod pⁱ), and any value is allowed in response to xϵZ. Gi over Zₚi is a j module and is essentially a constant function in all equivalence classes of p. This is because Gᵢ(j+p·x)=j is the same regardless of a value of x.

The definition of a Smarandache function is first described to facilitate description of the characteristics of polynomial representations of polyfunctions and how to obtain them.

Hereinafter, ab is written as a^{b}, and a\hat{ }b is written as a_b.

Definition 4.2 (Smarandache function): Smarandache function μ(·) is defined by μ(x)=min{iϵN:x|i!}. The number of multiples of p in consecutive p\hat{ }r integers is greater than or equal to r, and thus, u (p\hat{ }r)≤p\hat{ }r may be easily shown. Accordingly, hereinafter, p\hat{ }r is used as an upper limit of μ(p\hat{ }r). That is, μ(p\hat{ }r)=O(p\hat{ }r). Interestingly, it is known that any polyfunction over Z_{p\hat{ }r} may be represented by a polynomial of a degree less than μ(p\hat{ }r). This is more formally stated in Lemma 4.3 below.

Lemma 4.3: If f: Zₚr [symbol] Zₚr is a polyfunction, there is a polynomial representation f of a degree less than μ(p\hat{ }r).

There is an efficient method of finding such a ‘precise’ polynomial representation by using Newton interpolation. This is the direct application of a divided difference that is an interpolation technique frequently used in numerical analysis.

The LUT evaluation 510 is described in detail. It is assumed as an LUT over F: Zₚ^{r}→Zₚ is Zₚ^{r}. First, when an input of u^{r}ᵢ is i (mod p), a multiple of p is returned by removing the last digit, and otherwise, 0 is output. Given that a result of this polynomial is a multiple of p, the output may be homomorphically divided by p. This refers to a result that an upper r−1 bits of input x are returned only when x=i (mod p), and otherwise, 0 is returned.

Accordingly,

$${u}_{{i}_{2} , … , {i}_{r}} := ( \frac{{u}_{{i}_{2}}^{2}}{p} ) ◦…◦ ( \frac{{u}_{{i}_{r}}^{r}}{p} ) : {Z}_{{p}_{r}} ↦ {Z}_{p}$$

returns a most significant bit (MSB) of an input when the next r−1 bits are i₂, i₃, . . . , iᵣ, and otherwise returns 0. In other words, uᵢ_{₂}_{, . . . , i}_{ᵣ} may be represented by Equation 8 below.

$${u}_{{i}_{2 , … , {i}_{r}}} ( x ) = \{ \begin{matrix}⌊ x / {p}^{r - 1} ⌋ & if x = \overline{{i}_{2} {i}_{3} … {i}_{r}} ( mod {p}^{r - 1} ) \\ 0 & otherwise\end{matrix} \qquad Equation 8$$

Given that all functions are polyfunctions over Zₚ, a value of an LUT F may be interpolated for the MSB. More precisely, when finding a polynomial Fᵢ_{₂}_{, . . . , i}_{ᵣ}, this polynomial is Fᵢ_{₂}_{, . . . , i}_{ᵣ}(0)=0) and satisfies Fᵢ_{₂}_{, . . . , i}_{ᵣ}(j)=F(j̅ι̅₂̅,̅ .̅ .̅ .̅ ,̅ ι̅ᵣ̅)(1≤i₁<p). Then, Fᵢ_{₂}_{, i}_{₃}_{, . . . , i}_{ᵣ} ∘uᵢ_{₂}_{, . . . , i}_{ᵣ} returns a correct LUT value in an input format j̅ι̅₂̅ι̅₃̅ .̅ .̅ .̅ ι̅ᵣ̅ when j>0, and otherwise returns 0. Through this, the LUT F for an input greater than p^{r-1} may be easily evaluated by evaluating partial LUTs and summing all of them. In other words, the LUT F defined for Fᵢ_{₂}_{, . . . , i}_{ᵣ} and uᵢ_{₂}_{, . . . , i}_{ᵣ} as shown in Equation 9 below may output a correct value for an input of x≥p^{r-1}.

$${\sum }_{0 \leq {i}_{2} , … , {i}_{r} < p} {F}_{{i}_{2} , {i}_{3} , … , {i}_{r}} ◦ {u}_{{i}_{2} , … , {i}_{r}} \qquad Equation 9$$

To deal with the case of x<p^{r-1}, a ‘shifted’ input may be used to evaluate another LUT and add it to a previous LUT.

In this procedure, first, an LUT may be divided into p^{r-1} sub-LUTs over Zₚ for a numerical value of the lower r−1 digits. To homomorphically evaluate these sub-LUTs, an LUT to ‘select’ and evaluate each digit from the LSB to the MSB is determined, and a polynomial u^{r}ᵢ is used. From this, it may be seen that the LUT evaluation 510 may be realized as a polynomial evaluation with each digit as an input. Since all the functions having multiple inputs in Zₚ are polynomials, there is always a multivariate polynomial representation of the LUT F. Thus, after extracting all digits by using an original digit extraction method, a multivariate polynomial representation of an LUT may be calculated.

However, these two methods include an exponentially large number of evaluations of polynomials, for which execution time may not be practical. Next, it is shown that functions having special structures may be evaluated with low temporal complexity. There may be various functions to be easily evaluated, but the case of a step function is only described.

A basic step function has two intervals. It is assumed that an LUT F: Zₚ_{ᵣ} [symbol] Zₚ of a step function for a value aϵZₚ and a boundary BϵZₚ_{ᵣ} is defined as shown in Equation 10 below.

$$F ( x ) = \{ \begin{matrix}0 & if x < B \\ α & otherwise\end{matrix} \qquad Equation 10$$

Any step function including two intervals may be transformed into a simple step function by applying an appropriate linear combination to shift input and output data. Also, it is assumed that B≥p^{r-1}. Otherwise, another LUT F′(x):=F(x−B)−a that essentially has a boundary p^{r}−B≥p^{r-1} and a value −a may be used.

Now, a p-base representation is by b̅ᵣ̅₋̅₁̅ b̅ᵣ̅₋̅₂̅ .̅ .̅ .̅ b̅₀̅. If the LSB of the input x is less than b₀, the LUT F returns 0 only when the upper r−1 bits of the LUT F are less than b̅ᵣ̅₋̅₁̅ .̅ .̅ .̅ b̅₂̅(̅b̅₁̅+̅1̅)̅, and otherwise returns a. On the other hand, if the LSB of the input x is greater than b₀, the LUT F returns 0 when the upper r−1 bits of the LUT F are less than b̅ᵣ̅₋̅₁̅ .̅ .̅ .̅ b̅₂̅b̅₁̅, and otherwise returns a. Accordingly, the LUT F may be evaluated by being divided into two sub-LUTS, F^{r-1}₁, F^{r-1}₂:Zₚ_{_{r−1}} [symbol] Zₚ, defined as shown in Equation 11 below.

$${F}_{1}^{r - 1} = \{ \begin{matrix}0 & if x < \overline{{b}_{r - 1} … ( {b}_{1} + 1 )} \\ α & otherwise\end{matrix} , \\ {F}_{2}^{r - 1} = \{ \begin{matrix}0 & if x < \overline{{b}_{r - 1} … {b}_{1}} \\ α & otherwise\end{matrix} . \qquad Equation 11$$

Through this, the LUT F may be calculated by using the evaluation of the polynomial u^{r}ᵢ and the sub-LUTs F^{r-1}₁ and F^{r-1}₂. u^{r}ᵢ(x)/p outputs the upper r−1 bits when the LSB of the input x is i, and otherwise outputs 0. Accordingly, for a value x of which the LSB is i, F^{r-1}₁(u^{r}ᵢ/p) is evaluated when i<b₀, and F^{r-1}₂(u^{r}ᵢ/p) is evaluated when b₀≤i such that F(x) may be obtained. Since F^{r-1}₁(0)=F^{r-1}₂(0)=0, the LUT F may be evaluated by calculating a sum of F^{r-1}₁(u^{r}ᵢ/p) for 0≤i<b₀ and F^{r-1}₂(u^{r}ᵢ/p) for b₀≤i<p. In this method, two LUTs are essentially evaluated when 0≤i<b₀ and b₀≤i<p, respectively, and thus, a sum of the LUTs may be integrated as shown in Equation 12 below.

$$F ( x ) = {F}_{1}^{r - 1} ( {\sum }_{0 \leq i < {b}_{0}} {u}_{i}^{r} ( x ) / p ) + {F}_{2}^{r - 1} ( {\sum }_{{b}_{0} \leq i < p} {u}_{i}^{r} ( x ) / p ) \qquad Equation 12$$

Now, two sub-LUTS, F^{r-1}₁ and F^{r-1}₂, need to be evaluated. F^{r-1}₁ and F^{r-1}₂ share the same form as that of the existing LUT F. Specifically, F^{r-1}₁ and F^{r-1}₂ are step functions over Zₚ_{_{r −1}} having boundaries B₁:=bᵣ₋₁ . . . b₂(b₁+1) and B₂:=Bᵣ₋₁ . . . b₂b₁, respectively. Accordingly, these may also be divided into sub-LUTs. As F^{r-1}₁ and F^{r-1}₂ do not include the information of LSB b₀, the sub-LUTs of F^{r-1}₁ and F^{r-1}₂ are respectively independent of LSB b₁+1 and b₁ of the boundaries B₁ and B₂. B₁ and B₂ are different only in the LSB, and thus, the sub-LUTs of F^{r-1}₁ and F^{r-1}₂ need to be the same. These are denoted by F^{r-2}₁ and F^{r-2}₂. F^{r-2}₁ and F^{r-2}₂ may be defined by Equation 13.

$${F}_{1}^{r - 2} = \{ \begin{matrix}0 & if x < {b}_{r - 1} … ( {b}_{2} + 1 ) \\ α & otherwise\end{matrix} \\ {F}_{2}^{r - 2} = \{ \begin{matrix}0 & if x < {b}_{r - 1} … {b}_{2} \\ α & otherwise\end{matrix} . \qquad Equation 13$$

Like the evaluation of F and F^{r-1}₁ and F^{r-1}₂, F^{r-2}₁ and F^{r-2}₂ may be evaluated in a recursive manner. If x₁:=Σ_{0≤i<b}_{₀}uᵢ^{r}(x)/p·x₂:=Σ_{b}_{₀}_{≤i<p}uᵢ^{r}(x)/p, F(x) may be represented by Equation 14 below.

$$F ( x ) = {F}_{1}^{r - 2} ( {\sum }_{0 \leq i \leq {b}_{1}} {u}_{i}^{r - 1} ( {x}_{1} ) / p + {\sum }_{0 \leq i < {b}_{1}} {u}_{i}^{r - 1} ( {x}_{2} ) / p ) + {F}_{2}^{r - 2} ( {\sum }_{{b}_{1} < i < p} {u}_{i}^{r - 1} ( {x}_{1} ) / p + {\sum }_{{b}_{1} \leq i < p} {u}_{i}^{r - 1} ( {x}_{2} ) / p ) \qquad Equation 15$$

Inputs for the same LUT are integrated. Thus, it is sufficient to evaluate four polynomials of E_{0≤i≤b}_{₁}uᵢ^{r-1}(x₁)/p. Σ_{0≤i<b}_{₁}uᵢ^{r-1}(x₂)/p, Σ_{b}_{₁}_{<i<p}uᵢ^{r-1}(x₁)/p, and Σ_{b}_{₁}_{≤i<p}uᵢ^{r-1}(x₂)/p, and two interval functions F^{r-2}₁ and F^{r-2}₂ over Zₚr−2. These two interval functions F^{r-2}₁ and F^{r-2}₂ may be iteratively calculated through four polynomial evaluations and two LUT evaluations 510 in a small dimension in a similar manner. After the iteration is completed, F¹₁ and F¹₂, that is, two LUTs over Zₚ need to be evaluated, which is defined as shown in Equation 15 below.

$${F}_{1}^{1} = \{ \begin{matrix}0 & if x < {b}_{r - 1} \\ α & otherwise\end{matrix} , \\ {F}_{2}^{1} = \{ \begin{matrix}0 & if x < {b}_{r - 1} \\ α & otherwise\end{matrix} . \qquad Equation 15$$

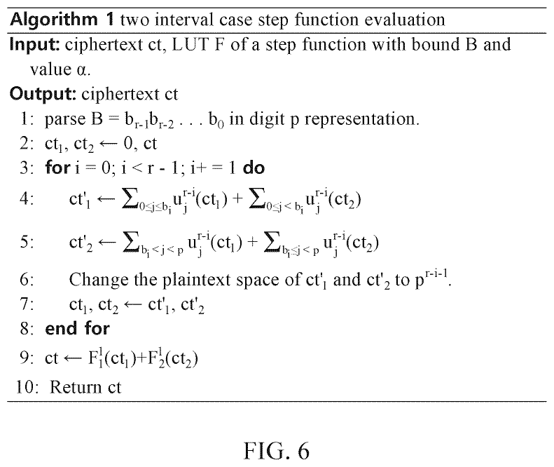

Since all functions over Zₚ are polyfunctions, all those functions have polynomial representations having integer coefficients, and each LUT may be evaluated through one polynomial evaluation. Based on these recurrence relations, an algorithm to evaluate a step function may be designed. An accurate algorithm based on this approach is provided as an example with reference to FIG. 6.

Additional optimization may be applied in a certain situation. For example, it is assumed that bᵢ=0 for 0≤i<r. Then, a polynomial Σ_{0≤j<b}_{ᵢ}uⱼ^{r-1}(ct₁) is essentially 0, and thus, an evaluation thereof may be skipped. In addition, if B has I 0s consecutively in the lowest bits, b₀=b₁= . . . =b₁₋₁=0, ct₁ is essentially 0 during I number of iterations. In this case, only one and two polynomial evaluations are needed at the beginning of an algorithm and at each iteration, respectively. In addition, if B has 0 in the lowest bit, the depth of multiplication may be saved at the expense of temporal complexity. Polynomials inherently remove the lower I digits, and thus, a digit removal algorithm may be used for the functional bootstrapping.

In an embodiment, the depth consumption and temporal complexity of another functional bootstrapping are analyzed. It is known that a polynomial of a degree d may be evaluated by consuming a ┌log d┐ level by using a non-scalar multiplication of 2√d. Based on this, the temporal complexity and depth consumption analysis is performed on a functional bootstrapping method.

Two interval cases: At an i-th iteration, four polynomials over Z_{q}r−i are evaluated. All polynomials over Z_{q}r−i have a maximum of a degree of μ(p^{r-i})≈p(r−i) through Lemma 4.3. Accordingly, their evaluations require a key switching operation of ≈4·2√p(r−i)=8√p(r−i) and the depth consumption of a≈log (pr) level. During r iterations, the key switching operation of Σᵢ₌₀^{r-1}8\sqrt{p(r−i)}≈16/3\sqrt{r³p} is performed and the multiplication depth of Σᵢ₌₀^{r-1} log (p(r−i))=rlogp+log r! is consumed.

The temporal complexity may be reduced by using various polynomial evaluation techniques. By adopting automorphism operations for polynomial evaluations, the temporal complexity of a single polynomial evaluation may be improved from 2√d to 3 log d. The result may be used as a black box for the evaluations of all polynomials over a finite field, and thus may also be applied to the temporal complexity optimization of the functional bootstrapping.

Several useful functions, such as a delta function or a sign function, may be selected, and the selected functions may be applied to the functional bootstrapping. A first target function is a delta function that returns 1 when an input is 0, and otherwise returns 0. The delta function may be expressed by Equation 16 below.

$$Delta ( x ) = \{ \begin{matrix}1 & if x = 0 \\ 0 & otherwise\end{matrix} \qquad Equation 16$$

In the functional bootstrapping, after switching a modulus from q^{r} to Q for the encryption of m, a ciphertext may be used as the encryption of └q^{r}/p]·m+e. Here, −q^{r}/2p≤e<q^{r}/2p. The boundary may be necessary for the accuracy of the ciphertext. Accordingly, a step function, like Equation 17 below, from Z_{q}r to Z needs to be evaluated for the delta function.

$$F ( x ) = \{ \begin{matrix}0 & if x < - {q}^{r} / 2 p \\ 1 & if - {q}^{r} / 2 p \leq x < {q}^{r} / 2 p \\ 0 & otherwise\end{matrix} \qquad Equation 17$$

Although the function F seems to be a step function of three intervals, the function F may be transformed into a two-interval case by moving a domain. A message space of an FV scheme is (−p/2, p/2] for a plaintext modulus. Thus, when replacing the input x with x−[p/2], the delta function is transformed into a function, like Equation 18 below.

### Equation 18

$$Delta ( x ) = \{ \begin{matrix}0 & if x < p - 1 \\ 1 & otherwise\end{matrix}$$

The function F may be changed as shown in Equation 19 below.

$$F ( x ) = \{ \begin{matrix}0 & if x < {q}^{r} - {q}^{r} / 2 p \\ 1 & otherwise\end{matrix} \qquad Equation 19$$

The evaluation/performance of the functional bootstrapping using a three-interval function has greater complexity than that of a two-interval function. As described above, complexity may be reduced by transforming the delta function into the two-interval function. An item having the same properties as a target value may be extracted by using the delta function.

Another useful step function may include a sign function that returns −1 when an input is a negative number, and otherwise returns 1. This function may be used in various ways. For example, the sign function is a main component of a comparison based on a sign value of a difference of two inputs. This comparison may be useful for various application programs, such as structured query language (SQL) queries of databases, assignment algorithms, or decision-making trees.

The sign function is a typical step function and may be expressed by Equation 20 below.

$$Sign ( x ) = \{ \begin{matrix}- 1 & if x < 0 \\ 1 & otherwise\end{matrix} \qquad Equation 20$$

Like the delta function, the LUT F from Z_{q}r to Z may be defined by Equation 21 below.

$$F ( x ) = \{ \begin{matrix}- 1 & if x < - {q}^{r} / 2 p \\ 1 & otherwise\end{matrix} \qquad Equation 21$$

If two LUTs are step functions having two intervals, the two LUTs may be easily calculated during the functional bootstrapping according to the algorithm provided as an example with reference to FIG. 6.

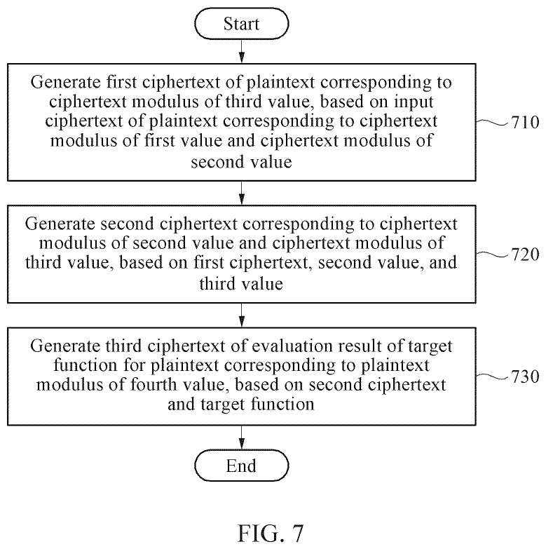

FIG. 7 illustrates an example of a bootstrapping method for a homomorphically encrypted ciphertext, according to an embodiment.

The bootstrapping method for a homomorphically encrypted ciphertext may correspond to the functional bootstrapping described above. Hereinafter, the bootstrapping method for a homomorphically encrypted ciphertext may be referred to as functional bootstrapping or a functional bootstrapping method.

Referring to FIG. 7, the functional bootstrapping method, according to an embodiment, may include operation 710 of generating a first ciphertext of a plaintext corresponding to a ciphertext modulus of a third value, based on an input ciphertext of the plaintext corresponding to a ciphertext modulus of a first value and a ciphertext modulus of a second value. For example, the first value may be p, and the second value may be Q.

The input ciphertext is data generated by encrypting a plaintext. The input ciphertext may be, for example, a ciphertext of an FV scheme or a ciphertext of a Cheon-Kim-Kim-Song (CKKS) scheme. For example, the input ciphertext may include an FV ciphertext encrypting a message vector. For example, the input ciphertext may include a CKKS ciphertext encrypting a message vector.

For example, the input ciphertext may include a ciphertext of a message vector \vec{m}=(mᵢ)_{0≤i k}, mᵢϵZₚ (0≤i<k), which is a plaintext. A message slot may include mᵢ values. For example, the input ciphertext may be a ciphertext of M(X):=m₀+m₁X^{d}+ . . . +mₖ₋₁X^{(k-1)d}, which is a polynomial form of a message vector. M(X) may be obtained through a slot-to-coefficient operation of \vec{m}. The slot-to-coefficient operation may be an operation of changing to a ciphertext of a polynomial having, as coefficients, the mi values included in the message slot. The slot-to-coefficient operation may include a linear transform or a homomorphic DFT.

The first ciphertext may include (c₀″, c₁″) satisfying

$${c}_{0}^{″} + {c}_{1}^{″} s = ( \frac{{q}^{r}}{p} ) \sum {m}_{i} {X}^{i} + e ( X ) ( mod {q}^{r} ) .$$

When the input ciphertext is a message vector form, that is, a ciphertext of a message vector mᵢϵZₚ(0≤i<k) the slot-to-coefficient operation may be performed to generate the first ciphertext. For example, according to an embodiment, operation 710 of generating the first ciphertext may include the transforming the first ciphertext of a message vector form into a polynomial form, and doing so based on the slot-to-coefficient operation. For example, a ciphertext (c₀′, c₁′) satisfying

$${c}_{0}^{′} + {c}_{1}^{′} s = ( \frac{{q}^{r}}{p} ) \vec{m} + {e}^{′} ( X ) ( mod {q}^{r} )$$

may be transformed into a ciphertext (c₀″, c₁″) of a polynomial form having mᵢ as a coefficient. The ciphertext (c₀″, c₁″) may be the first ciphertext.

According to one or more embodiments, the slot-to-coefficient operation may be performed on the input ciphertext. For example, the ciphertext of the message vector \vec{m}, which is a plaintext, may be transformed into a ciphertext of M(X). The ciphertext of M(X) may be the input ciphertext. The first ciphertext corresponding to the ciphertext modulus of the third value for the ciphertext of M(X) may be generated.

The functional bootstrapping method, according to one or more embodiments, may include operation 720 of generating a second ciphertext corresponding to the ciphertext modulus of the second value and the ciphertext modulus of the third value, based on the first ciphertext, the second value, and the third value. The third value may be q^{r}.

According to one or more embodiments, the operation 720 of generating the second ciphertext may include the generating of the second ciphertext by multiplying the first ciphertext by a reciprocal number of the third value and the second value. When the second value is Q and the third value is q^{r}, the second ciphertext of which the ciphertext modulus is Q and the plaintext modulus is q^{r} may be generated by multiplying the first ciphertext by

$$\frac{Q}{{q}^{r}} .$$

For example, the second ciphertext may include a ciphertext (c₀′″, c₁′″) that satisfies

$${c}_{0}^{′′′} + {c}_{1}^{′′′} s = ( Q / {q}^{r} ) ( ( \frac{{q}^{r}}{p} ) \sum {m}_{i} {X}^{i} + e ( X ) ) ( mod Q )$$

According to one or more embodiments, operation 720 of generating the second ciphertext may include the transforming of the second ciphertext of a polynomial form into a message vector form, based on the slot-to-coefficient operation. The slot-to-coefficient operation may include an inverse linear transform or an iDFT.

By transforming the second ciphertext of a polynomial form, coefficients of a plaintext may be moved to the message slot. The message slot of a ciphertext may include a

$$( \frac{{q}^{r}}{p} ) {m}_{i} + {e}_{i} .$$

value.

According to one or more embodiments, operations 710 and 720 may correspond to the plaintext modulus switching method described above.

The functional bootstrapping method, according to one or more embodiments, may include operation 730 of generating a third ciphertext of an evaluation result of a target function for the plaintext corresponding to a plaintext modulus of a fourth value, based on the second ciphertext and the target function. The third value may be the same as the fourth value or a power of the fourth value. In other words, the fourth value may be q, and the third value may be q^{r} (r may greater than or equal to 1). If r=1, the third value is the same as the fourth value, and, if r>1, the third value may be the power of the fourth value.

According to one or more embodiments, operation 730 may correspond to the LUT evaluation method described above.

As described above, the functional bootstrapping may perform a function evaluation during bootstrapping (in addition to the bootstrapping, and to alter the ciphertext). For example, if the target function is f, the third ciphertext may include a ciphertext of f(mᵢ). For example, the target function may include an LUT operation. In other words, an evaluation/performance of the target function may include the LUT evaluation described above. The LUT operation may include an operation of obtaining data stored in an LUT and may include, for example, private information retrieval (PIR). For example, the target function may include a step function.

According to one or more embodiments, operation 730 of generating the third ciphertext may include the moving of coefficients of the plaintext included in the second ciphertext of a polynomial form to a message slot, based on a slot-to-coefficient operation, and the generating of the third ciphertext based on a polynomial configured to map a value of the message slot of the second ciphertext to the evaluation result of the target function for the plaintext when the third value is the same as the fourth value.

As described above, when the slot-to-coefficient operation is performed, the message slot of the ciphertext may include the

$$( \frac{{q}^{r}}{p} ) {m}_{i} + {e}_{i}$$

value.

Under the assumption that the fourth value is q and the third value is q^{r}, if r=1, the third value is the same as the fourth value. When the third value is the same as the fourth value, operation 730 may correspond to an operation to transform

$$( \frac{q}{p} ) {m}_{i} + {e}_{i} ,$$

which is a value in the message slot, into f(mᵢ). All functions may be expressed as a polynomial in Z_{q}. Thus, a polynomial g that satisfies

$$g ( ( \frac{q}{p} ) {m}_{i} + {e}_{i} ) = f ( {m}_{i} )$$

may be found for all mᵢ, eᵢ combinations. The polynomial g may map a value of the message slot of the second ciphertext to an evaluation result of the target function for a plaintext.

According to one or more embodiments, operation 730 of generating the third ciphertext may include the moving of coefficients of the plaintext included in the second ciphertext of a polynomial form to a message slot, based on a slot-to-coefficient operation, and the switching of the plaintext modulus into an r−1 power of the fourth value by performing a division operation on the fourth value based on a polynomial where a value of the message slot is a multiple of the fourth value when the third value is an r power of the fourth value for a natural number r that is greater than or equal to 2.

The bootstrapping method may include the repeating of the switching of the plaintext modulus into the r−1 power of the fourth value until the plaintext modulus is switched to the fourth value and the generating of the third ciphertext based on a polynomial configured to map a value of the message slot of the second ciphertext to the evaluation result of the target function for the plaintext when the plaintext modulus is the fourth value.

Under the assumption that the fourth value is q and the third value is q^{r}, when the third value is an r power of the fourth value for a natural number r that is greater than or equal to 2, operation 730 may be an operation to transform

$$( \frac{{q}^{r}}{p} ) {m}_{i} + {e}_{i} ∈ {Z}_{{q}^{r}} ,$$

which is a value in the message slot, into f(mᵢ)ϵZ_{q}, starting from an initial plaintext modulus being q^{r}>q.

There may be cases in which a function of transforming

$$( \frac{{q}^{r}}{p} ) {m}_{i} + {e}_{i}$$

into f(mᵢ)ϵZ_{q} may not be expressed as a polynomial over Z_{q}. Thus, a plaintext modulus may be iteratively transformed from q^{r} into q^{r-1}, from q^{r-1} into q^{r-2}, . . . , from q² into q.

A plaintext modulus may be transformed into q^{r-1} by performing a division-by-q operation by selecting a polynomial that transforms a message vector to be a multiple of q. For example, if the second ciphertext is the ciphertext of M(X), and there is M′(X)ϵR_{q}r−1, which is M(X)=q·M′(X), the second ciphertext may be transformed into a ciphertext of M′(X), in which the plaintext modulus is q^{r-1}.

If a plaintext modulus becomes q by repeating a process of reducing an index of the plaintext modulus by 1 for r−1 times, the third ciphertext that encrypts f(mᵢ) by finding a polynomial g that satisfies

$$g ( ( \frac{q}{p} ) {m}_{i} + {e}_{i} ) = f ( {m}_{i} )$$

for all mᵢ, eᵢ combinations, like when r=1.

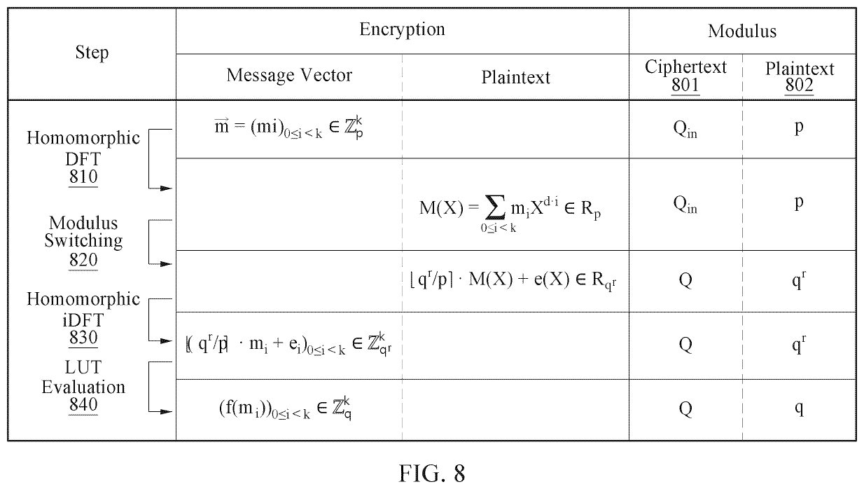

FIG. 8 illustrates an example of a changing process of a modulus and a ciphertext in a functional bootstrapping process, according to one or more embodiments.

Referring to FIG. 8, a plaintext modulus 802 is p, a ciphertext modulus 801 is Qᵢₙ, and a ciphertext encrypting a vector \vec{m} corresponds to input data of functional bootstrapping. A ciphertext of \vec{m} may be changed to a ciphertext of ( ):=0+1+ . . . +−1⁽⁻¹⁾ in a polynomial form through homomorphic discrete Fourier transform 810.

The plaintext modulus 802 may be switched to q^{r} through plaintext modulus switching 820, and a ciphertext of I·M(X)+e(X) may be obtained. The ciphertext of I·M(X)+e(X) may correspond to the first ciphertext described above.

Through a homomorphic iDFT 830, the ciphertext in a polynomial form may be transformed to a ciphertext of I·i+i in a message vector form. The ciphertext of I·i+i may be obtained by performing an inverse discrete Fourier transform on the second ciphertext described above.

Through an LUT evaluation 840, a ciphertext of f(mᵢ) may be output. The output data of the functional bootstrapping may be a ciphertext encrypting f(mᵢ) in which the plaintext modulus 802 is q and the ciphertext modulus 801 is Q. The ciphertext of f(mᵢ) may correspond to the third ciphertext described above.

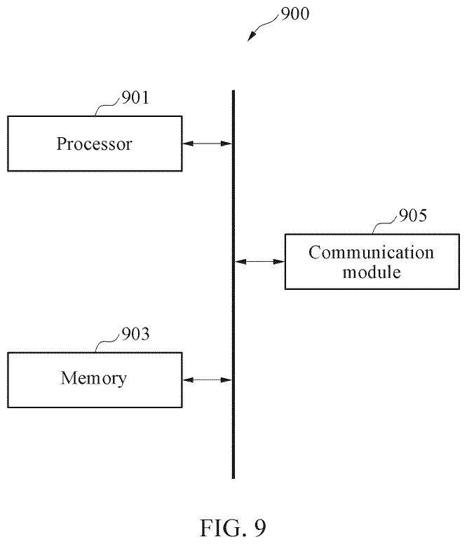

FIG. 9 illustrates an example configuration of an apparatus according to one or more embodiments.

Referring to FIG. 9, an apparatus 900 may include a processor 901, a memory 903, and a communication module 905. The apparatus 900 according to an embodiment may include an apparatus that performs the functional bootstrapping method described above with reference to FIGS. 1 to 8. The processor 901 is representative of one or more processors that may be used in practice.

Although much of the description above is in the language of mathematical notation, it will be appreciated that the mathematical notation is an efficient description of the operations of a device such as the apparatus 900. Given the mathematical notation above, and the accompanying text and drawings, an engineer can readily formulate source code that mirrors the mathematical and textual description. Such source code may be compiled to produce executable code that, when executed by the processor 901, causes the processor 901 to perform the operations described by the mathematical notation and textual description herein. Similarly, an engineer may readily derive a hardware specification that can be translated, using known tools, into a circuit design which in turn can be implemented using known fabrication techniques. In short, the mathematical notation herein is not the direct subject matter of the instant application, but rather is a convenient (arguably necessary) shorthand language for describing actual code, instructions, hardware, and the like.

The processor 901 may perform at least one operation of the functional bootstrapping method described above with reference to FIGS. 1 to 8. For example, the processor 901 may perform at least one of an operation of generating a first ciphertext of a plaintext corresponding to a ciphertext modulus of a third value (e.g., q^{r}), based on an input ciphertext of the plaintext corresponding to a ciphertext modulus of a first value (e.g., p) and a ciphertext modulus of a second value (e.g., Q), an operation of generating a second ciphertext corresponding to the ciphertext modulus of the second value and the ciphertext modulus of the third value, based on the first ciphertext, the second value, and the third value, and an operation of generating a third ciphertext of an evaluation result of a target function for the plaintext corresponding to a plaintext modulus of a fourth value (e.g., q), based on the second ciphertext and the target function.

The memory 903 may be a volatile memory or a non-volatile memory (but not a signal per se) and may store data related to the functional bootstrapping method described above with reference to FIGS. 1 to 8. For example, the memory 803 may store data generated during a process of performing the functional bootstrapping method, or data necessary for performing the functional bootstrapping method.

According to an example, the memory 803 may store a program configured to implement the functional bootstrapping method described above with reference to FIGS. 1 to 8. The processor 901 may execute the program stored in the memory 903 and may control the apparatus 900. Code from the program executed by the processor 901 may be stored in the memory 903.

The communication module 905 according to an embodiment may provide a function for the apparatus 900 to communicate with another electronic device or another server through a network. In other words, the apparatus 900 may be connected to an external device (e.g., a terminal of a user, a server, or a network) through the communication module 905 and may exchange data with the external device.

According to one or more embodiments, the memory 903 may not be a component of the apparatus 900 and may be included in an external device accessible by the apparatus 900. In this case, the apparatus 900 may receive data stored in the memory 903 included in the external device and may transmit data to be stored in the memory 903 through the communication module 905.

The apparatus 900 may further include other components not shown in the drawings. For example, the apparatus 900 may further include an input/output interface including an input device and an output device as the means of interfacing with the communication module 905. In addition, for example, the apparatus 900 may further include other components, such as a transceiver, various sensors, or a database.

The apparatus 900 may include an accelerator. The accelerator may be a hardware component for processing a homomorphic encryption operation. For example, the accelerator may process addition and/or multiplication operations of homomorphic encryption.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or collectively instruct or configure the processing unit to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The computing apparatuses, the electronic devices, the processors, the memories, the displays, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A bootstrapping method for a homomorphically encrypted ciphertext, the bootstrapping method performed by one or more processors and comprising:
generating a first ciphertext of a plaintext corresponding to a ciphertext modulus of a third value, based on an input ciphertext of the plaintext corresponding to a ciphertext modulus of a first value and corresponding to a ciphertext modulus of a second value;
generating a second ciphertext corresponding to the ciphertext modulus of the second value and corresponding to the ciphertext modulus of the third value, based on the first ciphertext, the second value, and the third value; and
generating a third ciphertext of an evaluation result of a target function for the plaintext corresponding to a plaintext modulus of a fourth value, based on the second ciphertext and the target function, wherein
the third value is the same as the fourth value or a power of the fourth value.

2. The bootstrapping method of claim 1, wherein the generating of the first ciphertext comprises transforming the first ciphertext of a message vector form into a polynomial form, based on a slot-to-coefficient operation.

3. The bootstrapping method of claim 1, wherein the generating of the second ciphertext comprises transforming the second ciphertext of a polynomial form into a message vector form, based on a slot-to-coefficient operation.

4. The bootstrapping method of claim 1, wherein the generating of the second ciphertext comprises generating the second ciphertext by multiplying the first ciphertext by a reciprocal of the third value and the second value.

5. The bootstrapping method of claim 1, wherein the generating of the third ciphertext comprises:
moving coefficients of the plaintext comprised in the second ciphertext of a polynomial form to a message slot, based on a slot-to-coefficient operation; and
generating the third ciphertext based on a polynomial configured to map a value of the message slot of the second ciphertext to the evaluation result of the target function for the plaintext when the third value is the same as the fourth value.

6. The bootstrapping method of claim 1, wherein the generating of the third ciphertext comprises:
moving coefficients of the plaintext comprised in the second ciphertext of a polynomial form to a message slot, based on a slot-to-coefficient operation; and
switching the plaintext modulus into an r−1 power of the fourth value by performing a division operation on the fourth value based on a polynomial where a value of the message slot is a multiple of the fourth value when the third value is an r power of the fourth value for a natural number r that is greater than or equal to 2.

7. The bootstrapping method of claim 6, further comprising:
repeating the switching of the plaintext modulus into the r−1 power of the fourth value until the plaintext modulus is switched to the fourth value; and
generating the third ciphertext based on a polynomial configured to map a value of the message slot of the second ciphertext to the evaluation result of the target function for the plaintext when the plaintext modulus is the fourth value.

8. The bootstrapping method of claim 1, wherein the target function comprises a look-up table (LUT) operation.

9. The bootstrapping method of claim 1, wherein the target function comprises a step function.

10. The bootstrapping method of claim 1, wherein the input ciphertext is generated using a Fan-Vercauteren (FV) scheme or a Cheon-Kim-Kim-Song (CKKS) scheme.

11. A non-transitory computer-readable storage medium storing instructions that, when executed by the one or more processors, cause the one or more processors to perform the bootstrapping method of claim 1.

12. An apparatus for performing a bootstrapping method for a homomorphically encrypted ciphertext, the apparatus comprising one or more processors configured to:
generate a first ciphertext of a plaintext corresponding to a ciphertext modulus of a third value, based on an input ciphertext of the plaintext corresponding to a ciphertext modulus of a first value and corresponding to a ciphertext modulus of a second value;
generate a second ciphertext corresponding to the ciphertext modulus of the second value and corresponding to the ciphertext modulus of the third value, based on the first ciphertext, the second value, and the third value; and
generate a third ciphertext of an evaluation result of a target function for the plaintext corresponding to a plaintext modulus of a fourth value, based on the second ciphertext and the target function, wherein
the third value is the same as the fourth value or a power of the fourth value.

13. The apparatus of claim 12, wherein the one or more processors are further configured to, when generating the first ciphertext, transform the first ciphertext of a message vector form into a polynomial form, based on a slot-to-coefficient operation.

14. The apparatus of claim 12, wherein the one or more processors are further configured to, when generating the second ciphertext, transform the second ciphertext of a polynomial form into a message vector form, based on a slot-to-coefficient operation.

15. The apparatus of claim 12, wherein the one or more processors are further configured to, when generating the second ciphertext, generate the second ciphertext by multiplying the first ciphertext by a reciprocal of the third value and the second value.

16. The apparatus of claim 12, wherein the one or more processors are further configured to, when generating the third ciphertext,
move coefficients of the plaintext comprised in the second ciphertext of a polynomial form to a message slot, based on a slot-to-coefficient operation, and
generate the third ciphertext based on a polynomial configured to map a value of the message slot of the second ciphertext to the evaluation result of the target function for the plaintext when the third value is the same as the fourth value.

17. The apparatus of claim 12, wherein the one or more processors are further configured to, when generating the third ciphertext,
move coefficients of the plaintext comprised in the second ciphertext of a polynomial form to a message slot, based on a slot-to-coefficient operation, and
switch the plaintext modulus into an r−1 power of the fourth value by performing a division operation on the fourth value based on a polynomial where a value of the message slot is a multiple of the fourth value when the third value is an r power of the fourth value for a natural number r that is greater than or equal to 2.

18. The apparatus of claim 17, wherein the one or more processors are further configured to
repeat the switching of the plaintext modulus into the r−1 power of the fourth value until the plaintext modulus is switched to the fourth value, and
generate the third ciphertext based on a polynomial configured to map a value of the message slot of the second ciphertext to the evaluation result of the target function for the plaintext when the plaintext modulus is the fourth value.

19. The apparatus of claim 12, wherein the target function comprises an LUT operation or a step function.

20. The apparatus of claim 12, wherein the target function is performed on the ciphertext while noise of the ciphertext is reduced.
